(19) United States
(12) Patent Application Publication
(10) Pub. No.: US 2004/0191749 A1
(43) Pub. Date: Sep. 30, 2004

(54) Method and template for evaluating designated pairs of responses on a master answer sheet

(76) Inventor: William E. Lynch III, Fredericksburg, VA (US)

Correspondence Address: William H. Holt, Law Offices of William H. Holt, 12311 Harbor Drive, Woodbridge, VA, 22192, US

(21) Appl. No.: 10/813,082

(22) Filed: Mar. 31, 2004

Related U.S. Application Data
(60) Provisional application No. 60/458,411, filed on Mar. 31, 2003.

(51) Int. Cl. G09B 7/00

(52) U.S. Cl. 434/353

(57) ABSTRACT

A method for evaluating, comparing and scoring designated pairs of responses to a series of questions that have been recorded directly by the examinee on a master answer sheet by darkening spaces corresponding to the selected answer. A template is placed over the master answer sheet and each of a series of designated responses are paired together and evaluated by following a path, as designated on the template, which joins each of the designated pairs of responses together and allows the responses to be visible through the template.

### BACKGROUND AND FIELD OF THE INVENTION

This invention relates to a method for evaluating, comparing and scoring, on a master answer sheet, designated pairs of responses to a series of questions that have been recorded by an examinee. This invention relates to a method for scoring designated pairs of responses that are located randomly across a master answer sheet and it precludes the need to search for and transfer said pairs of responses onto another sheet for scoring.

Many important tests and assessments involve self-reports of individuals wherein the individuals are asked to respond to a series of questions by endorsing either true or false, depending on how they believe the statement applies to them. In order to ascertain the validity of the self-reports of individuals, the consistency and variability of the overall self-report is determined by evaluating and comparing the individual's responses to designated pairs of responses that were given throughout the self-report. The degree of variability and inconsistency is determined by noting the number of times that specific response patterns are endorsed within each designated pair of questions. The pairs of questions related to the critical responses are located randomly throughout the test and it is often quite cumbersome to locate and identify the responses to the questions that are being evaluated.

Current hand scoring practice of some validity scales requires that the responses to all pairs of designated questions be transferred to a separate answer sheet wherein a scoring template is laid across the second answer sheet, and each pair of responses is evaluated on the second sheet. This process is very time consuming and leads to potential errors in the process of transferring numerous responses from one sheet to another. One known test requires the person scoring the results to transfer 138 adult responses or 126 adolescent responses from the client's answer sheet. After the responses are transferred to a supplementary answer sheet, scoring templates are placed over the responses and the number of inconsistent responses are identified and tabulated. This process is time consuming, and prone to error. Computer scoring is possible, less time consuming, but more expensive than hand-scoring. Thus a more practical, more efficient, method for hand-scoring was needed.

Test answer and scoring sheet configurations are generally known. Some examples are U.S. Pat. No. 2,977,689 and U.S. Pat. No. 1,883,199. A method of evaluating designated response to a series of questions is disclosed in U.S. Pat. No. 5,102,341. An apparatus for scoring an examination answer sheet is shown and described in U.S. Pat. No. 4,074,445. A method of scoring designated responses to a series of questions is disclosed in U.S. Pat. No. 4,943,239.

### SUMMARY OF THE INVENTION

The present invention relates to a method and template whereby a series of pairs of responses are located and evaluated on an original response sheet by following a pathway as designated on the scoring template. The novel scoring template is positioned on a master answer sheet by lining up designated marks on the template with corresponding marks on the answer sheet. The pathway on the scoring template joins each pair of responses together and allows the client's, or examinee's, responses to be visible through the template for evaluation. Each response pair is joined together with the other response pairs in a series that allows the scorer to follow the pathway and evaluate a multitude of designated response pairs. The responses may be consecutively numbered, or lettered, etc., along the pathway and/or arrows may be used to make it easier to identify the route that should be followed. Each pair of answers, or responses, is clearly distinguished and linked together in some manner, i.e. a solid line, dashed line, color coded, alternating between pairs of responses that are denoted by circles and pairs of responses that are denoted by squares. The template itself can be partially transparent or translucent so that the client's answers are visible through the template, or a modified version of a template may have holes punched it through at the appropriate locations.

### BRIEF DESCRIPTION OF THE DRAWINGS

FIG. 1 is a plan view of a novel scoring template used for locating designated pairs of responses on a master answer sheet, in accordance with a preferred embodiment of the present invention.

### DETAILED DESCRIPTION OF PREFERRED EMBODIMENT

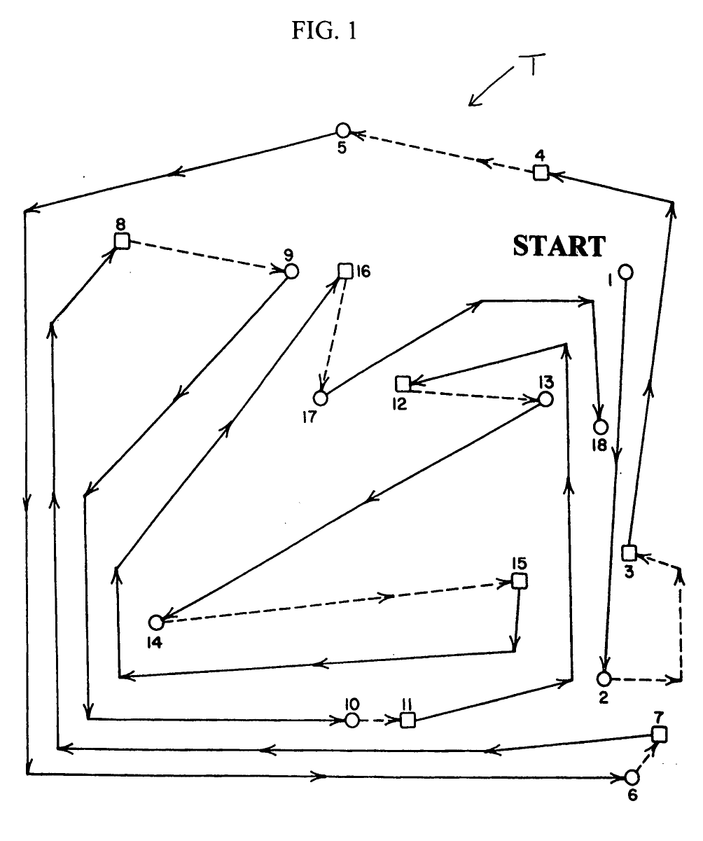

Referring now to the drawing, FIG. 1 is a plan view of a scoring template, generally indicated by the letter T, which is to be used to score designated pairs of answers or responses on a master answer sheet. The scoring template T is laid on top of a conventional answer sheet, not shown. It is to be understood that conventional answer sheets include, inter alia, a series of symmetrically arranged circles, or squares or rectangles to be filled in, usually with a solid pencil mark, or the like, accompanied by a series of numbers indicating the question that is being responded to.

Typical test procedures include a series of related questions that are spaced through out the test so that the related answers are also spaced through out the answer sheet. Any particular template T is construct to be used with a related answer sheet. Once the template T is precisely oriented upon its related answer sheet using, for example, well known indexing points or indicia, the person scoring the test results simply starts at the point indicated on template T as “START” and thereafter follows the lines, arrows, and/or numbering, printed upon the template.

It is to be noted that the sequential numbers, i.e., “1” and “2” are correlated with matching circles, numbers “3” and “4” are paired or correlated with small rectangles, and this pairing of related answers continues throughout the remaining pathway about template T. Thus, answers appearing in related circles, squares, or other possible shapes, are considered as being matched pairs and are then scored accordingly, either mentally or tabulated upon a related score sheet.

A series of critical responses, are thereby identified by the pairs of circles, squares, etc. or, alternatively, by a colored line, or by any other indicia that clearly links the related pair together. Each pair of critical responses is thereby joined to other pairs of critical responses by a different form of indicia so that the indicia joining a set of critical responses is clearly distinguished from the indicia between a set of critical responses. The critical responses are numbered consecutively, i.e., 1, 2, 3, 4, and so on, and may be used to lead the scorer along the pathway, although this is not necessary. The template T can be printed on a transparent or translucent medium that allows the critical responses to be visible through the template at each response position, or the template can be printed on an opaque medium and holes may be punched for each of said responses wherein each response position, or pairs of critical responses, can be identified by circles, or squares, and so forth, as explained or by any other geometric shape. The scorer follows the pathway from one end to the other on template T and notes the response pattern for each critical response pair, as indicated by the darkened responses visible through the template. The scorer follows pre-determined criteria for evaluating each response pair. For example, a response pair may be noteworthy only if both of the responses are darkened. The direction in which the pathway is followed is not critical.

While the foregoing description represents a preferred embodiment of the invention, it is to be understood that it will be obvious to those skilled in this art that various changes and modification may be made without departing from the spirit and scope of the invention as defined in the appended claimed subject matter.

I claim:

1. A template for evaluating and scoring designated pairs of responses, said template comprising a series of paired locations thereon, a first set of said locations being linked by indicia on said template, a pathway leading from said first set of locations to at least a second set of locations, said pathway being shown by said indicia for leading a user from said first set to said second set of locations, each of said locations allowing for viewing through said template.

2. A template as defined in claim 1 wherein said indicia comprises a series of lines connecting the sets together.

3. A template as defined in claim 2 wherein said indicia is comprised of a series of alternating solid lines and broken lines.

4. A template as defined in claim 1 wherein each pair of locations is identified by a common geometric shape.

5. A template as defined in claim 4 wherein each pair of locations is identified by an identical geometric shape, and the next consecutive pair in said series is identified by a different geometrical shape.

6. A method for evaluating designated pairs of responses to a series of questions, said method including the steps of positioning a template upon an answer sheet, and following a pathway for identifying pairs of answers to a plurality of paired questions, and evaluating said pairs of answers to said paired questions.

7. A method as defined in claim 6 wherein said pathway is comprised of a continuous line.
